(19) United States
(12) Patent Application Publication
(10) Pub. No.: US 2024/0393772 A1
(43) Pub. Date: Nov. 28, 2024

(54) Method for Monitoring a Production Line for Producing Components, in Particular for Motor Vehicles

(71) Applicant: Bayerische Motoren Werke Aktiengesellschaft, Muenchen (DE)

(72) Inventors: Bernhard GLUECK, Fuerstenfeldbruck (DE); Ingo HEINLE, Inzell (DE)

(21) Appl. No.: 18/685,269

(22) PCT Filed: Oct. 12, 2022
(86) PCT No.: PCT/EP2022/078358

§ 371 Date: Feb. 21, 2024

(30) Foreign Application Priority Data
Oct. 22, 2021 (DE) 10 2021 127 549.0

(51) Int. Cl. G05B 19/418

(52) U.S. Cl. CPC G05B 19/41875; G05B 2219/32187

(57) ABSTRACT

A method monitors a production line for producing components, in which at least one signal is provided if it is determined that, after a first period of time within which at least one first parameter, the varying of which influences production, is varied multiple times and at least one second parameter, the varying of which influences the production and/or monitoring of the production and/or monitoring of the particular component and/or checking of the particular component that is produced, is not constantly varied, the at least one second parameter is varied at least once within a second period of time following the first period of time.

### BACKGROUND AND SUMMARY

The invention relates to a method for monitoring a production line for producing components, in particular for motor vehicles.

A system for assisting big data in a process control system is known from DE 10 2014 102 844 A1, comprising a unitary logical data storage area, which includes one or more data storage devices configured to store data using a common format, which correspond to at least one process controlled by the process system or a process controlled in the process system. Furthermore, US 2016/0098647 A1 discloses a system for providing big data-based learning in a process system which controls a process.

The object of the present invention is to provide a method for monitoring a production line for producing components so that the components can be produced with a particularly high quality.

This object is achieved by methods in accordance with the independent claims. Advantageous embodiments of the invention are the subject matter of the dependent claims.

A first aspect of the invention relates to a method for monitoring a production line for producing components, in particular for motor vehicles. For example, the production line is or comprises at least one forming device for forming the components, also designated as workpieces, and/or for forming workpieces from which the components are produced. For example, in the method the components or the workpieces are formed by means of the forming device. In particular, the components in this case can be components for motor vehicles. This is to be understood to mean in particular that the components are used, for example, to produce motor vehicles designed, for example, as automobiles, in particular as passenger vehicles. Therefore, for example, the production line is used during or for production of the motor vehicles so that, for example, the method is used, therefore carried out, during or in the mentioned production. The forming device can be, for example, a press or the forming device can comprise at least one press. In other words, the forming device can be, for example, a press device, which can comprise at least or exactly one press for forming the components. In particular, the forming can be deep drawing, so that the forming device is designed, for example, for deep drawing the components.

A production method designed, for example, as a forming method can be carried out or is carried out to produce, in particular form, the respective component by means of the production line, in particular by means of the forming device, wherein the production method is also designated as a production process and the forming method is also designated as a forming process. The forming method can therefore, for example, be a deep drawing method or the forming process can be a deep drawing process. In particular, it is contemplated here that for the respective component, i.e., to produce the respective component, in particular to form it, the production process, in particular the forming process, is carried out at least or precisely once by means of the production line, in particular by means of the forming device, so that, for example, when the components are produced in succession by means of the production line, in particular are formed in succession by means of the forming device, the production process, in particular the forming process, is carried out repeatedly in succession, i.e., one time after another. The basic concept of the invention additionally relates to following steps of the production process, also designated as a component production process, within the production line designed, for example, as a press line or comprising at least one press line, thus also, for example, cutting and stamping operations. In other words, it is contemplated that the components are alternatively or additionally cut and/or stamped and/or processed in another manner by means of the production line.

To now be able to form the components by means of the production line with a particularly high quality, therefore to be able to carry out the production process also designated as a producing process repeatedly in succession with a particularly high quality, it is provided according to the invention that in the method, in particular by means of an electrical or electronic unit, at least one electrical signal, for example, is provided, in particular output, when it is determined, in particular by means of an electronic computing device, by means of which the method is carried out, for example, that after a first time span, within which at least one first parameter, i.e., one or more first parameters, the variation of which influences the production, in particular the forming, therefore the production process, in particular the forming process, is or are varied multiple times and a variation of at least one second parameter, the variation of which influences the production, in particular the forming, therefore the production process, in particular the forming process, and/or monitoring of the production, in particular of the forming, therefore of the production process, in particular the forming process, and/or monitoring of the respective component and/or checking of the respective produced, in particular formed, component, does not take place continuously, i.e., without interruption, the at least one second parameter is varied at least one time within a second time span, for example, directly following the first time span. It is contemplated here that the signal designed as a notification signal, for example, characterizes the variation of the second parameter. In particular, the electronic computing device can be the unit.

The feature that the second time span, for example, directly follows the first time span is to be understood in particular to mean that the second time span begins when the first time span ends, therefore a beginning of the second time span coincides with an end of the first time span. In other words, it is preferably provided that no other, third time span lies between the first time span and the second time span. However, it is readily contemplated that a third time span lies between the first time span and the second time span. The production process is carried out here, for example, within or during the first time span and within or during the second time span, wherein a further production process different from the production process is carried out, for example, within or during the third time span.

It is contemplated that a notification signal is used as the signal, which is output by means of a playback device, in particular to the surroundings of the playback device and/or the production device and is thus provided, or by means of the signal at least one notification signal is caused to be output, in particular to the surroundings, and thus provided by means of a playback device. Furthermore, it is contemplated that the signal causes at least one component of the production line initially moving for the production, for example, to end its movement and remain stationary and/or change its movement, i.e., to continue to move, but in a different way than before the signal is provided. In this way, for example, the production is influenced, in particular at least temporarily ended, i.e., for example, at least temporarily interrupted. Furthermore, it is contemplated that the signal is electronically further processed after it is provided, for example, by a further, in particular electrical or electronic unit, which can be a component of the computing device, by which the production is influenced, in particular is at least temporarily ended or interrupted. For example, the signal can be evaluated and further processed by machine. Examples of this are an alarm also designated as alerting, in particular by outputting the notification signal, triggering of a system stop, i.e., at least temporarily ending or interrupting the production, an in particular independent adjustment of the production line, also designated as the system or production system, or of the first and/or second parameter.

In particular if the signal is used as the notification signal or causes the output of the notification signal, the feature that the signal and/or the notification signal characterizes the variation of the second parameter is to be understood in particular to mean that the signal and/or notification signal communicates, therefore informs a person located in the surroundings, for example, of the varying of the at least one second parameter, also designated as variation, which takes place or occurs within the second time span. Alternatively or additionally, for example, the varying of the second parameter taking place within the second time span is communicated to the person such that or in that as a result of or due to the provision of the signal, the component ends or changes its movement and/or that as a result of or due to the provision of the signal, the production is influenced. In still other words, the person can be notified, therefore alerted, of the varying of the at least one second parameter taking place within the second time span by the signal and/or the notification signal, i.e., by the provision of the signal.

Furthermore, the parameters can be understood in particular as the following: The feature that by varying the at least one first parameter, the production, in particular the forming, i.e., the production process, in particular the forming process, is varied, is to be understood to mean that the production, i.e., carrying it out, is varied by varying the at least one first parameter. In other words, for example, when the at least one first parameter has a first value, the production process is carried out in a first way. If the at least one first parameter has a second value different from the first value or, for example, if multiple first parameters are used, one of the first parameters has a second value different from the first value, in particular while the or all other first parameters still have the first value, the production is carried out in a second manner different from the first manner. This is transferable accordingly to the feature that, for example, by varying the at least one second parameter, the production, in particular the forming, therefore the production process, in particular the forming process, is varied, i.e. is changed, in particular with regard to carrying it out. The at least one first parameter or the first parameters is or are also designated as process parameters, in particular because the at least one first parameter is changed, i.e., varied multiple times within the first time span, in particular multiple times alternately or successively, in particular with regard to its value, whereas the at least one second parameter is not varied within the first time span. Typically, the process parameter is or the process parameters are varied, i.e., changed if, for example, problems occur, i.e., if the production, in particular the forming, is possibly not carried out as desired, i.e., does not lead to desired results. The at least one second parameter, which is also designated simply as the second parameter, is also designated as a setting or setting parameter. It is contemplated in particular here that at least or precisely one further second parameter or multiple further second parameters are provided, wherein the following and preceding statements on the at least one second parameter are also readily transferable to the further second parameter or the further second parameters and vice versa. The setting parameter is typically set, in particular defined, in particular one time, during a startup of the production line, in particular the forming device, in particular at least one or more tools of the production line, in particular of the forming device, and thereupon is only changed, i.e., varied, rarely in particular in comparison to the process parameters, during operation, in particular during a lifecycle, of the production line, in particular the forming device, and/or the production process, in particular the forming process, and/or a manufacturing process comprising the production process, in particular the forming process.

The invention is now based in particular on the finding that upon an occurrence of problems such as quality problems, i.e., if the production process does not lead to a desired result, a change influencing, therefore changing, the production process is performed, which is not supposed to be performed. This change can comprise, for example, that the at least one second parameter (setting parameter) is varied, i.e., changed, although it is not supposed to be changed, in particular due to the absence of the varying of the at least one second parameter during the first time span. Due to the large number of options for influencing, i.e., changing, the production process, wherein these options comprise, for example, varying the at least one first parameter and varying the at least one second parameter, it is typically not possible or is only possible with great effort to recognize undesired influences or changes of the production process, therefore, for example, undesired varying of the at least one second parameter. If, for example, undesired influencing of the production process is carried out upon an occurrence of quality problems in that, for example, the at least one second parameter is varied, this can lead not to an improvement but rather a worsening of the production process and therefore even greater quality problems. The challenge is therefore to recognize undesired influences, in particular changes, of the production process so that such an undesired influence of the production process, for example, undesired varying of the at least one second parameter, can be reversed again as promptly as possible, i.e., as soon as possible after varying of the at least one second parameter. For this purpose, the invention proposes monitoring at least the at least one second parameter or in relation to the at least one first parameter and the at least one second parameter, exclusively the at least one second parameter and if and preferably only if the at least one second parameter is varied and in this way, for example, exceeds or falls below a comparison value and/or a value range, providing the signal. The at least one first parameter is, for example, not monitored or the at least one first parameter is monitored, but is excluded with regard to providing the signal, in particular with regard to outputting the notification signal, in particular such that, for example, providing the signal, in particular outputting the notification signal, does not take place if the at least one first parameter is changed within the second time span. The preceding and following statements on the at least one first parameter are also readily transferable to the first parameters and vice versa. The at least one first parameter is or characterizes, for example, forces in or by cylinders, by means of which, for example, the respective component is produced, in particular formed, i.e., for example, component A, and the at least one second parameter is or characterizes an activity. Therefore, for example, the activity is observed depending on the program number.

In particular, the goal can be followed and achieved by the invention of providing quality management and planning of action recommendations for maintaining robust production processes and thus for ensuring high quality of products to be produced such as vehicles to persons who operate facilities for carrying out the production by means of data which can be obtained during a production of components, in particular workpieces, very particularly semifinished products and very particularly blanks, and/or components. For example, sensors are used to detect a quality of the components before the respective production, in particular before respective forming, and/or after the respective production, in particular forming, and, for example, to deposit quality data characterizing the detected quality in particular in a central database, i.e., to store them. Furthermore, it is contemplated to store the at least one first parameter and/or the at least one second parameter or the values thereof, for example, to unambiguously assign the detected quality or the quality data to the respective individual workpiece.

For example, the respective component, in particular workpiece, is a semifinished product, in particular a blank and very particularly a metal blank.

In addition, the method according to the invention now enables possibly undesired varying of the at least one second parameter to be recognized and a person located in the above-mentioned surroundings to be notified, in particular by means of the signal, of the possibly undesired varying of the at least one second parameter. In still other words, the person becomes aware that the at least one second parameter was varied, therefore changed, due to the signal, i.e., as a result of or due to the provision of the signal. If the varying of the at least one second parameter took place intentionally, the person can thus take note of the signal, in particular the notification signal, for example, wherein the varying of the at least one second parameter is not reversed, for example. However, if the person in particular recognizes on the basis of the signal, in particular the notification signal, that the varying of the at least one second parameter should not have taken place, therefore has taken place in an undesirable manner, the person can thus reverse the varying of the at least one second parameter. Furthermore, it is contemplated that at least one measure can be taken, in particular by the person, to avoid further undesired varying of the at least one second parameter taking place in the future. The varying of the at least one second parameter can be understood in particular to mean that, for example, the at least one second parameter is set, i.e., changed from a first setting value to a second setting value different from the first setting value. In other words, for example, the at least one second parameter initially has the first setting value, wherein the varying of the at least one second parameter comprises, for example, that the second setting value of the at least one second parameter is set, which is different from the first setting value. For example, the person, after they have experienced the notification signal from the varying of the at least one second parameter, can reverse the varying of the at least one second parameter and can therefore reset, for example, the at least one second parameter from the second setting value to the first setting value, or the person can set the at least one second parameter from the second setting value to a third setting value different from the first and second setting value to avoid further escalation of quality problems.

Furthermore, for example, the varying of the at least one second parameter can be understood to mean, for example, that due to or during the varying of the at least one second parameter, at least one device, which is in particular initially activated, is deactivated or an initially deactivated device is activated. The device is, for example, an apparatus which influences the production, in particular the forming, for example, in that it is activated or deactivated, respectively. The device can in particular be a component of the production line, in particular the forming device, or an apparatus provided in addition to the production line and thus the forming device. In particular, it is provided in this regard that, however, the possible deactivation of the device does not end or deactivate the production as such, but rather in particular it is contemplated that due to activating or deactivating of the device or in spite of activating or deactivating of the initially deactivated or activated device, respectively, the production, in particular forming, nonetheless can be carried out or is carried out.

Therefore, at least the following advantages can be implemented by the invention:
avoiding inadvertent changing of setting values, therefore of the at least one second parameter;
monitoring an arbitrary number of setting values or second parameters (setting parameters) with very little personnel expenditure;
no maintenance of target setting values required.

To identify undesired changes, i.e., variations of parameters particularly reliably and therefore to be able to implement a particularly high quality of the forming, it is provided in one advantageous embodiment of the invention that during the first time span and during the second time span, both the at least one first parameter and the at least one second parameter are monitored as to whether the at least one first parameter and the at least one second parameter are varied, wherein the signal, in particular the notification signal, is provided, in particular output, if and only if the at least one second parameter is varied within the second time span. In other words, it is provided that both the at least one first parameter and the at least one second parameter are monitored, wherein, however, the at least one first parameter is excluded from the providing, in particular outputting, of the signal, in particular the notification signal. This means that the signal is not provided if the at least one first parameter is changed within the second time span and varying of the at least one second parameter does not take place, however.

A second aspect of the invention relates to a method for monitoring a production line for producing components, in particular for motor vehicles. For example, the production line is or comprises a forming device for forming the components, which are therefore workpieces or are also designated as workpieces, for example. In the method according to the second aspect of the invention, at least one in particular electrical signal is provided, in particular by means of an electrical or electronic unit, if it is determined, in particular by means of an electronic computing device, by means of which, for example, the method according to the second aspect of the invention is carried out, that after a first time span, within which at least one first parameter, the varying of which influences the production, is varied multiple times and at least one second parameter, the varying of which influences the production and/or monitoring of the production and/or monitoring of the respective component and/or checking of the respective produced component, is varied at least once and nonetheless less often than the at least one first parameter, the at least one second parameter is varied within a second time span, in particular directly following the first time span, such that a setting value of the at least one second parameter deviating from a reference value is set. Advantages and advantageous embodiments of the first aspect of the invention are to be viewed as advantages and advantageous embodiments of the second aspect of the invention and vice versa. Moreover, the preceding and following statements on the first aspect of the invention can also be readily transferred to the second aspect of the invention and vice versa.

The method according to the second aspect of the invention is not necessarily fundamentally directed to notifying of varying of the at least one second parameter, but rather the method according to the second aspect of the invention is directed in particular to alerting a person located in the surroundings of the production line, for example, by the provision of the signal that the setting value of the at least one second parameter, which in particular excessively deviates from the reference value and, for example, is undesired or unfavorable, is or was set, therefore the setting value of the at least one second parameter deviates, in particular excessively, from the reference value. The person can thereupon, for example, reverse the setting of the setting value, in particular such that the at least one second parameter is set to the reference value. Undesired changing, therefore varying, of the at least one second parameter can also be communicated to the person by the method according to the second aspect of the invention, due to which, for example, an escalation, in particular a further escalation, of quality problems possibly resulting from the setting of the setting value can be avoided.

It has proven to be particularly advantageous if in the second aspect of the invention the reference value is determined in dependence on the varying of the at least one second parameter taking place within the first time span. Alternatively or additionally, it can be provided that the reference value is determined in dependence on at least one or precisely one parameter value of the at least one second parameter set within the first time span. In other words, in particular the following is conceivable: within or during the first time span, for example, multiple components are produced, in particular in succession, by means of the production line, in particular formed by means of the forming device, so that the production process, in particular the forming process, is carried out multiple times in succession within or during the first time span. In particular in the first aspect of the invention, precisely one parameter value of the at least one second parameter is set within the first time span, since in the first aspect of the invention varying of the at least one second parameter does not take place within the first time span. In other words, in particular in the first aspect of the invention, the at least one second parameter has the same parameter value within or during the first time span continuously or without interruption or for each performance of the production process, in particular the forming process, taking place within the first time span. In still other words, in particular in the first aspect of the invention, the precisely one or the same parameter value of the at least one second parameter is used for each production process performed within the first time span. This means that, for example, for each production process performed within the first time span, the same parameter value of the at least one second parameter is set. As a result, for example, the precisely one parameter value of the at least one second parameter set within the first time span and in particular for each production process performed within the first time span is then used as the reference value. If it is then determined, for example, in particular in the first aspect of the invention, that within the second time span the at least one second parameter is changed to the setting value, in particular from the parameter value set within the first time span, therefore the setting value of the at least one second parameter is set, the notification signal is thus output.

In particular with regard to the second aspect of the invention, it is provided that the at least one second parameter is varied at least once and preferably more than once within the first time span, so that within the first time span, at least two parameter values different from one another, in particular more than two parameter values different from one another, of the at least one second parameter are set. It is therefore contemplated in particular in the second aspect of the invention that for at least one or for multiple production processes performed within the first time span, a first parameter value of the at least one second parameter is set and for at least one or for multiple production processes performed within the first time span, a second parameter value of the at least one second parameter different from the first parameter value is set. For example, it is therefore contemplated that the production process is carried out n times within the first time span, while the first parameter value of the at least one second parameter is set, and that the production process is performed m times within the first time span, while the second parameter value of the at least one second parameter different from the first parameter value is set, so that the first parameter value is or was set n times and the second parameter value is or was set m times within the first time span. In this case, n and m each designate a natural number, wherein it is contemplated in particular that n and/or m are greater than 1. Furthermore, it is self-evidently contemplated that the production process is performed p times within the first time span, while a third parameter value of the at least one second parameter different from the first and second parameter value is set, so that the third parameter value is or was set p times within the first time span. In this case, p also designates a natural number which is 1 or preferably greater than 1. It is contemplated here, for example, that the parameter value of the at least one second parameter set most frequently within the first time span is used as the reference value. For example, for the or each parameter value of the at least one second parameter set within the first time span, a respective associated number or a respective associated numeric value is determined, which represents how often the respective associated parameter value is or was set within the first time span. Then, for example, that one of the determined numbers or that one of the determined numeric values is used as the reference value which is the greatest number or greatest numeric value in relation to the determined numbers or numeric values and preferably additionally exceeds a limit, which is in particular predeterminable or predetermined. Therefore, the following can be provided in particular in the second aspect of the invention: The method according to the invention can in particular automatically monitor the production process, in particular with regard to the at least one second parameter and its parameter value or setting value. In particular with regard to the reference value and in particular its determination, a statistical observation of the past can take place, i.e., the preceding production processes and the respective parameter values set in each case of the at least one second parameter. For example, over a defined period such as the first time span, the associated parameter value of the at least one second parameter is determined for each manufactured, i.e., produced component. In other words, for example, the respective parameter value of the at least one second parameter set during the respective production process is determined. If the parameter value was the same within the first time span or for each production process performed within the first time span, this parameter value is used as, i.e., considered to be, the standard value or standard setting, therefore the reference value. If, for example, the currently used setting value, i.e., the setting value set within the second time span, deviates from the reference value so that the setting value falls below or exceeds the reference value, the signal is provided so that, for example, a notification or a warning, in particular in the form of the notification signal, is output or communicated to the person. If multiple parameter values of the at least one second parameter different from one another are or were set, for example, for the production processes performed within the first time span, an associated number of manufactured or produced components is thus determined depending on the parameter value of the at least one second parameter set within the first time span. In other words, for example, it is determined how often which parameter value of the at least one second parameter is or was set within the first time span. If the same parameter value of the at least one second parameter was set for a large part of the components produced, i.e., manufactured within the first time span, this parameter value is thus used as the standard value, therefore as the reference value. If, for example, the quotient of the greatest of the determined numbers and the sum of the or all determined numbers of the parameter values of the at least one second parameter set within the first time span is greater than a limit, which could be, for example, 0.95 or 95%, so that in 95% or more of the production processes performed within the first time span, i.e., the components manufactured within the first time span, a parameter value of the at least one second parameter is or was set, this parameter value is thus used as the reference value. If none of the numbers reaches or exceeds the required limit in particular, for example, no assessment of the currently set setting value is carried out. An at least almost arbitrary number of parameters and/or parameter values can be monitored without manual effort by this method. If only a single parameter value or setting value deviates from the determined standard value or reference value, a warning can thus be output, in particular in the form of the notification signal.

For this purpose, monitoring and in particular recording or storing of the parameter values of the at least one second parameter set in particular within the first time span or used for the or all production processes performed within the first time span, in particular with respect to the components manufactured within the first time span, is advantageous. In some cases, a direct access to the parameter values of the at least one second parameter can prove to be complex. This could require programming of additional interfaces, which can be carried out readily, however.

In a further, particularly advantageous embodiment of the second aspect of the invention, it is provided that during the first time span and during the second time span, both the at least one first parameter and the at least one second parameter are monitored as to whether the at least one first parameter and the at least one second parameter are varied, wherein the signal is only provided if the at least one second parameter is varied within the second time span such that the setting value deviating from the reference value and therefore, for example, from a reference value range is set. In this way, the production, therefore the production processes, can be monitored advantageously and in particular automatically so that a particularly high quality can be represented.

A further embodiment is distinguished in that at least one of the first parameters is also varied within the second time span at least once, in particular multiple times, in each case. In this way, the components can be produced and therefore manufactured with a particularly high quality, wherein, however, the first parameters are excluded from the outputting of the notification signal. The components can thus also be produced particularly quickly.

In a further, particularly advantageous embodiment it is provided that a notification signal, which is output by means of a playback device and thus provided, is used as the signal.

It is preferably provided here that the notification signal is output by means of the playback device as a notification signal optically and/or acoustically perceptible by a person located in the surroundings of the forming device. In this way, the person can be alerted particularly effectively and efficiently that the at least one second parameter was varied or that the setting value was set. As a result, quality problems can be avoided.

To be able to notify the person particularly effectively and efficiently of the varying of the at least one second parameter or of the setting of the setting value, it is provided in a further embodiment of the invention that the notification signal is displayed on an electronic display of the playback device and/or is output by means of a sound transducer, therefore by means of a loudspeaker of the playback device.

A further embodiment provides that the signal causes at least one initially moving component of the production line to end its movement and remain stationary and/or change its movement.

It has furthermore proven to be particularly advantageous if the signal is electronically further processed after it is provided, by which the production is influenced.

In a further, particularly advantageous embodiment of the invention, data which characterize the varying of the at least one second parameter taking place within the second time span are stored in an electronic data memory of a or the electronic computing device. In this way, a continuous and particularly high-quality manufacturing or production process can be implemented.

Finally, it has proven to be particularly advantageous if a cooling device for cooling the respective component and/or for cooling the forming device can be activated and deactivated during the forming by the varying of the second parameter. In particular, it can thus be recognized by the method whether the cooling device, designed as a water cooling device, for example, is or was inadvertently deactivated, although it is also supposed to be activated for the forming processes to be performed within the second time span.

Alternatively or additionally, a detection system for detecting a crack of the respective component resulting from the forming can be activated and deactivated by the varying of the second parameter. The method therefore makes it possible to recognize whether the detection system, also designated as a crack detection system was deactivated, although it is also supposed to be activated for the forming processes to be performed within the second time span.

In particular, for example, the feature that the varying of the at least one second parameter influences a production, in particular a forming, of the respective component is to be understood to mean that, for example, a monitoring system can be influenced, in particular can be activated and deactivated, by the varying of the at least one second parameter, wherein the monitoring system is, for example, the above-mentioned detection system, and wherein, for example, the monitoring system is designed to monitor the production, in particular the forming as such. Accordingly, for example, the feature that the monitoring of the respective component is influenced by the varying of the at least one second parameter is to be understood to mean that, for example, a system can be influenced, in particular can be activated and deactivated, by varying the at least one second parameter, by means of which the respective component can be monitored during the production, in particular during the forming, of the respective component. Furthermore, the feature that the checking of the respective produced, in particular formed, component can be influenced by the varying of the at least one second parameter is therefore to be understood to mean that, for example, a device such as the above-mentioned detection system can be influenced, in particular can be activated and deactivated, by the varying of the at least one second parameter, which is designed, for example, to check the respective component after its production, in particular forming, in particular for a presence of cracks resulting from the production, in particular forming. Examples of the varying of the at least one second parameter are therefore, for example, activating or deactivating of a cooler for cooling the production line, in particular the forming device, and using a blank holder pre-acceleration, for example, in a head press of a pressing train of the production line, in particular of the forming device. The crack detection system is a system for assisting the production, in particular the forming, for example, to be able to detect cracks occurring during the production, in particular forming, early. Such systems can usually be configured in dependence on the respective component to be produced or formed, wherein an example of such a configuration is the activation or deactivation of the system, in particular the crack detection system. The method therefore enables in particular undesired deactivation of the crack detection system to be automatically detected and the person to be alerted thereof. It is therefore also possible, for example, to check an activation of the crack detection system for a specific production process on the basis of the generated data. If the system or the method has not generated messages or notification signals in the past of the defined period, it can thus be presumed that it is not activated as a standard feature for the associated forming process to be carried out in particular within the second time span, so that, for example, the deactivation of the crack detection system is desired. The outputting of the notification signal then does not take place, for example.

Further details of the invention result from the following description of preferred exemplary embodiments with the associated drawings.

### BRIEF DESCRIPTION OF THE DRAWINGS

FIG. 1 is a flow chart illustrating a first embodiment of a method for monitoring a production line for producing components; and

FIG. 2 is a flow chart illustrating a second embodiment of the method.

### DETAILED DESCRIPTION OF THE DRAWINGS

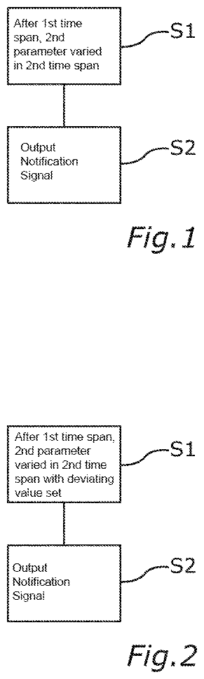

A first embodiment of a method for monitoring a production line for producing components, in particular for motor vehicles, is explained hereinafter on the basis of FIG. 1. For example, the production line is or comprises at least one forming device by means of which the components are formed and thus produced, in particular as workpieces. It can therefore be provided in particular in the method that in the method at least the forming device for forming the components is monitored, wherein the components are also designated hereinafter as workpieces. For example, the method and the production line and thus the forming device are used in a production of motor vehicles preferably designed as automobiles, in particular as passenger vehicles, which are produced by means of the workpieces. Thus when reference is made hereinafter to the forming device and to “forming” and to the workpieces, these are to be understood as the production line, the production, and the components. In the production, the workpieces are formed, in particular successively, by means of the forming device and thus manufactured, in particular in that the forming device carries out at least one forming process, also designated as a manufacturing process, per workpiece. Since the multiple workpieces are formed successively by means of the forming device, the forming process is carried out multiple times in succession. Since the forming process is carried out multiple times in succession during the production, reference is also made hereinafter to forming processes. When reference is made to the forming processes, this is to be understood in particular as the repeated successive performance of the forming process.

In the method, the forming process is carried out multiple times in succession within a first time span, so that a number of performances of the forming process greater than 1 and in particular greater than 2 takes place within the first time span. In a first step S1 of the first embodiment of the method, it is determined by means of an electronic computing device, by means of which the method is carried out, that after the first time span, within which multiple first parameters, the varying of which influences the forming, therefore the forming process, are varied multiple times and varying of at least one second parameter, the varying of which influences the forming and/or monitoring of the forming and/or monitoring of the respective workpiece and/or checking of the respective formed workpiece, continuously does not take place, the at least one second parameter is varied at least once within a second time span directly following the first time span. This means that in the first embodiment, the at least one second parameter has or has had the same first parameter value during each forming process performed within the first time span, wherein, however, the at least one second parameter is set to a second parameter value, which is different from the first parameter value and is also designated as the setting value, within the second time span. This is detected by means of the electronic computing device. As a result, in a second step S2 of the method, at least one signal is provided by means of a playback device, which is electrical or electronic in particular, such that the signal is output as a notification signal in particular to the surroundings of the playback device and the forming device by means of the playback device, wherein the notification signal characterizes the varying of the at least one second parameter taking place within the second time span. The notification signal is a signal that is acoustically and/or optically perceptible by a person located in the surroundings, by which the person was alerted that the at least one second parameter was varied within the second time span, in particular was set to the setting value. As a result, for example, the person can reverse the varying of the at least one second parameter, in particular if the person comes to the conclusion in dependence on the notification signal that the varying of the at least one second parameter that took place within the second time span occurred inadvertently. Quality problems can thus be avoided, so that the workpieces can be formed with a particularly high quality. For example, in the first embodiment of the method, the notification signal is output if and preferably only if the setting value, to which the at least one second parameter is set within the second time span, deviates from a reference value, which is predetermined or predeterminable in particular, in particular such that a deviation of the setting value from the reference value exceeds a limit, which is predetermined or predeterminable in particular. In this case, for example, the reference value is determined in dependence on the first parameter value of the at least one second parameter set within the first time span or for the forming processes performed within the first time span, in particular such that, for example, the first parameter value set within the first time span or for the forming processes performed within the first time span is used as the reference value.

FIG. 2 illustrates a second embodiment of the method. In the second embodiment of the method, it is determined in the first step S1 that after the first time span, within which the multiple first parameters are varied multiple times and the at least one second parameter is varied at least once but less often than the first parameter, the at least one second parameter is varied within the second time span directly following the first time span such that the setting value of the at least one second parameter deviating from the reference value is set. As a result, in the second step S2 of the method, the signal is provided such that the signal is output as the notification signal by means of the playback device. It is therefore provided in the second embodiment of the method that within the first time span the at least one second parameter is varied, but less often than the respective first parameter. In particular, for example, it can be provided that within the first time span for n performances of the forming process, a first parameter value of the at least one second parameter is set and, for example, within the first time span for m performances of the forming process, a second parameter value of the at least one second parameter, which is different from the first parameter value, is set and, for example, within the first time span for p performances of the forming process, a third parameter value of the at least one second parameter, which is different from the first and second parameter value, is set. In this case, m, n, and p each designate a natural number which is preferably greater than 1.

It has proven to be advantageous here if in the second embodiment, the reference value is determined in dependence on the variation of the at least one second parameter taking place within the first time span. In the second embodiment, m, n, and p are therefore numeric values which represent or express how often the respective parameter value is or was set within the first time span, i.e., how often the forming process was or is performed, while the respective parameter value of the at least one second parameter was or is set. For example, that one of the numeric values is determined as the reference value which is the greatest numeric value and additionally preferably exceeds a predeterminable or predetermined limit. The respective numeric value is also designated as the number of the production process or performance of the production process. For example, for each numeric value a respective associated proportional value is determined in that the respective numeric value is divided by the sum of the or all determined numeric values. For example, that one of the numeric values is determined as the reference value, whose associated proportional value is the greatest proportional value and is additionally preferably greater than or equal to a threshold value which is, for example, 0.95 or 95%. Therefore, a statistical observation of the parameter values of the at least one second parameter set in the past, i.e., within the first time spans, is carried out, by which a particularly high-quality manufacturing or forming of the workpieces can be ensured.

1.-13. (canceled)

14. A method for monitoring a production line for producing components, comprising:
after a first time span within which at least one first parameter, a varying of which influences production, is varied multiple times and at least one second parameter, the varying of which influences the production and/or monitoring of the production and/or monitoring of a respective component and/or checking of the respective component that is produced, is not constantly varied, determining that the at least one second parameter is varied at least once within a second time span following the first time span; and
providing a signal output when it is determined that the at least one second parameter is varied at least once within the second time span following the first time span.

15. The method according to claim 14, wherein
during the first time span and during the second time span, both the at least one first parameter and the at least one second parameter are monitored as to whether the at least one first parameter and the at least one second parameter are varied, and
the signal is only provided when the at least one second parameter is varied within the second time span.

16. A method for monitoring a production line for producing components, comprising:
after a first time span within which at least one first parameter, a varying of which influences production, is varied multiple times and at least one second parameter, the varying of which influences the production and/or monitoring of the production and/or monitoring of a respective component and/or checking of the respective produced component, is varied at least once and less often than the at least one first parameter, determining that the at least one second parameter is varied within a second time span following the first time span such that a setting value of the at least one second parameter deviating from a reference value is set; and
providing a signal output when it is determined that the at least one second parameter is varied within a second time span following the first time span such that a setting value of the at least one second parameter deviating from a reference value is set.

17. The method according to claim 16, wherein
the reference value is determined in dependence on the varying of the at least one second parameter taking place within the first time span and/or in dependence on at least one parameter value of the at least one second parameter set within the first time span.

18. The method according to claim 16, wherein
during the first time span and during the second time span, both the at least one first parameter and the at least one second parameter are monitored as to whether the at least one first parameter and the at least one second parameter are varied, and
the notification signal is only output if the at least one second parameter is varied within the second time span such that the setting value deviating from the reference value is set.

19. The method according to claim 14, wherein
the at least one first parameter is also varied one or more times within the second time span.

20. The method according to claim 16, wherein
the at least one first parameter is also varied one or more times within the second time span.

21. The method according to claim 14, wherein
a notification signal, which is output by a playback device, is the signal output.

22. The method according to claim 21, wherein
the notification signal is output by the playback device, as a notification signal that is to be optically and/or acoustically perceptible by a person located in surroundings of the forming device.

23. The method according to claim 22, wherein
the notification signal is displayed on an electronic display of the playback device and/or is output by a sound transducer of the playback device.

24. The method according to claim 16, wherein
a notification signal, which is output by a playback device, is the signal output.

25. The method according to claim 24, wherein
the notification signal is output by the playback device, as a notification signal that is to be optically and/or acoustically perceptible by a person located in surroundings of the forming device.

26. The method according to claim 25, wherein
the notification signal is displayed on an electronic display of the playback device and/or is output by a sound transducer of the playback device.

27. The method according to claim 14, wherein
the signal causes at least one initially moving component of the production line to end its movement and remain stationary and/or to change its movement.

28. The method according to claim 14, wherein
the signal is electronically further processed after being provided, by which the production is influenced.

29. The method according to claim 14, wherein
data which characterize the varying of the at least one second parameter taking place within the second time span are stored in an electronic data memory of an electronic computing device.

30. The method according to claim 14, wherein by way of the varying of the second parameter:
a cooling device for cooling the respective workpiece and/or the forming device during the forming is activatable and deactivatable, and/or
a detection system for detecting a crack of the respective workpiece resulting from the forming is activatable and deactivatable.

31. The method according to claim 16, wherein
the signal causes at least one initially moving component of the production line to end its movement and remain stationary and/or to change its movement.

32. The method according to claim 16, wherein
data which characterize the varying of the at least one second parameter taking place within the second time span are stored in an electronic data memory of an electronic computing device.

33. The method according to claim 16, wherein by way of the varying of the second parameter:
a cooling device for cooling the respective workpiece and/or the forming device during the forming is activatable and deactivatable, and/or
a detection system for detecting a crack of the respective workpiece resulting from the forming is activatable and deactivatable.
